(19) United States
(12) Patent Application Publication
(10) Pub. No.: US 2005/0180076 A1
(43) Pub. Date: Aug. 18, 2005

(54) Electrostatic discharge protection circuit

(75) Inventors: Noriaki Saito, Kawasaki (JP); Kenji Hashimoto, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 10/912,150

(22) Filed: Aug. 6, 2004

(30) Foreign Application Priority Data
Feb. 18, 2004 (JP) 2004-041775

(51) Int. Cl. H02H 3/20

(52) U.S. Cl. 361/91.1

(57) ABSTRACT

A space-saving electrostatic discharge protection circuit that protects an internal circuit effectively against an ESD. When a positive ESD voltage is applied to a power supply terminal VDD, a PMOS is in the on state for time determined by a time constant given by a first resistor and a capacitor and the voltage of a gate of an NMOS rises due to voltage generated across a second resistor. As a result, the potential of a substrate is raised, a parasitic bipolar transistor on the NMOS turns on at a low drain voltage, an electric current generated by the ESD flows to a power supply terminal VSS via a power supply line, and the internal circuit is protected.

### CROSS-REFERENCE TO RELATED APPLICATIONS

This application is based upon and claims the benefits of priority from the prior Japanese Patent Application No. 2004-041775, filed on Feb. 18, 2004, the entire contents of which are incorporated herein by reference.

### BACKGROUND OF THE INVENTION

(1) Field of the Invention

This invention relates to an electrostatic discharge protection circuit and, more particularly, to an electrostatic discharge protection circuit for protecting an internal circuit against an electrostatic discharge.

(2) Description of the Related Art

Minute semiconductor devices, such as large scale integrated circuits (LSIs), may discharge due to electrostatic charges provided from the outside, resulting in the degradation of characteristics or failure.

Accordingly, LSIs include electrostatic discharge protection circuits (ESD protection circuits) for protecting an internal circuit from an electrostatic discharge (ESD) voltage applied to a power supply terminal or a signal input-output terminal.

FIG. 8 is a circuit diagram of a conventional ESD protection circuit.

An ESD protection circuit 800 comprises a power supply clamping section 810 including an n-channel metal oxide semiconductor (MOS) field effect transistor (NMOS) 811 for preventing an ESD voltage from being applied to an internal circuit 900 and a gate voltage control section 820 for controlling the voltage of a gate of the NMOS 811 included in the power supply clamping section 810.

The power supply clamping section 810 includes the NMOS 811 which is electrically connected between a power supply line 901 connected to a power supply terminal VDD and a power supply line 902 connected to a power supply terminal VSS. One input-output terminal (drain or source) of the NMOS 811 is connected to the power supply line 901 via a resistor 812 and the other input-output terminal of the NMOS 811 is connected to the power supply line 902. In FIG. 8, a parasitic bipolar transistor 811a, a parasitic resistor 811b, and a parasitic diode 811c on the NMOS 811 are notionally shown by dotted lines.

For example, a positive DC voltage is applied to the power supply terminal VDD and the power supply terminal VSS is connected to a ground (GND).

The gate voltage control section 820 has a complementary MOS (CMOS) inverter structure and includes a p-channel MOS field effect transistor (PMOS) 821 and an NMOS 822. One input-output terminal of the PMOS 821 is connected to the power supply line 901 and the other input-output terminal of the PMOS 821 is connected to one input-output terminal of the NMOS 822 and a gate terminal of the NMOS 811 included in the power supply clamping section 810. One input-output terminal of the NMOS 822 is connected to the other input-output terminal of the PMOS 821 and the gate terminal of the NMOS 811 included in the power supply clamping section 810 and the other input-output terminal of the NMOS 822 is connected to the power supply line 902. Gate terminals of the PMOS 821 and the NMOS 822 are both connected to the power supply line 901.

The operation of the conventional ESD protection circuit 800 will now be described.

It is assumed that a positive DC voltage is applied to the power supply terminal VDD with the power supply terminal VSS as reference (GND). Then in the gate voltage control section 820 the PMOS 821 turns off and the NMOS 822 turns on. As a result, the gate terminal of the NMOS 811 in the power supply clamping section 810 is electrically connected to the power supply line 902 and the NMOS 811 turns off. Accordingly, the positive DC voltage applied to the power supply terminal VDD will be supplied to the internal circuit 900 and the internal circuit 900 performs predetermined operation.

When a positive ESD voltage is applied to the power supply terminal VDD with the power supply terminal VSS as reference (GND), an avalanche breakdown will occur in a depletion layer in an n-type drain junction area in the NMOS 811. As a result, the potential of a substrate will rise. When the difference between the potential of a base and emitter of the parasitic bipolar transistor 811a reaches about 0.7V, the parasitic bipolar transistor 811a turns on and an electric current generated by an ESD flows to the power supply terminal VSS via the power supply line 902 and the internal circuit 900 is protected. When a negative ESD voltage is applied to the power supply terminal VSS with the power supply terminal VDD as reference (GND), the internal circuit 900 will be protected in the same way.

When a positive ESD voltage is applied to the power supply terminal VSS with the power supply terminal VDD as reference (GND), the parasitic diode 811c which will turn on at about 0.7V is forward-biased. When the parasitic diode 811c turns on, an electric current generated by an ESD flows to the power supply terminal VDD and the internal circuit 900 is protected. When a negative ESD voltage is applied to the power supply terminal VDD with the power supply terminal VSS as reference (GND), the internal circuit 900 will be protected in the same way.

Furthermore, in FIG. 8, parasitic capacitance (not shown) between the drain and gate of the NMOS 811 is used for raising the voltage of the gate of the NMOS 811. This raises the potential of the substrate and decreases a voltage at which the parasitic bipolar transistor 811a turns on. That is to say, the parasitic bipolar transistor 811a turns on easily.

In addition, an ESD protection circuit in which a capacitance element (having a capacitance of, for example, about several picofarads) is connected between a gate and drain of an NMOS to control the voltage of its gate is disclosed (see, for example, Japanese Unexamined Patent Publication No. Hei6-163824, FIG. 1).

### SUMMARY OF THE INVENTION

An electrostatic discharge protection circuit for protecting an internal circuit against an electrostatic discharge, according to the present invention, comprises: a power supply clamping section including an n-channel MOS field effect transistor electrically connected between a first power supply line connected to a first power supply terminal and a second power supply line connected to a second power supply terminal; and a gate voltage control section for controlling the voltage of a gate of then-channel MOS field effect transistor, wherein the gate voltage control section includes: a p-channel MOS field effect transistor one input-output terminal of which is connected to the first power supply line and the other input-output terminal of which is connected to a gate terminal of the n-channel MOS field effect transistor; a first resistor one terminal of which is connected to the other input-output terminal of the p-channel MOS field effect transistor and the gate terminal of the n-channel MOS field effect transistor and the other terminal of which is connected to the second power supply line; a second resistor one terminal of which is connected to the first power supply line and the other terminal of which is connected to a gate terminal of the p-channel MOS field effect transistor; and a capacitor one terminal of which is connected to the other terminal of the second resistor and the gate terminal of the p-channel MOS field effect transistor and the other terminal of which is connected to the second power supply line.

The above and other features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a circuit diagram showing the principles underlying an ESD protection circuit according to an embodiment of the present invention.

FIG. 2 is a detailed circuit diagram of an ESD protection circuit according to an embodiment of the present invention.

FIG. 3 shows the transient characteristics of the conventional ESD protection circuit at the time of an ESD voltage being applied.

FIG. 4 shows the transient characteristics of the ESD protection circuit according to the embodiment of the present invention at the time of an ESD voltage being applied.

FIG. 5 is a circuit diagram of an ESD protection circuit for protecting an internal circuit at the time of an ESD voltage being applied to an input signal terminal of the internal circuit.

FIG. 6 shows the structure of the gate voltage control section included in the ESD protection circuit shown in FIG. 5 for controlling the voltage of the gate of the NMOS.

FIG. 7 is a circuit diagram of an ESD protection circuit for protecting an internal circuit at the time of an ESD voltage being applied to an input signal terminal of the internal circuit, according to another embodiment of the present invention.

FIG. 8 is a circuit diagram of a conventional ESD protection circuit.

### DESCRIPTION OF THE PREFERRED EMBODIMENTS

With conventional ESD protection circuits in which a voltage at which a parasitic bipolar transistor on an NMOS in a power supply clamping section turns on is decreased by using parasitic capacitance, the value of the parasitic capacitance is smaller than or equal to 1 femtofarad. Accordingly, a voltage at which the parasitic bipolar transistor turns on cannot be decreased drastically. Therefore, an electric current generated by an ESD may flow to an internal circuit, resulting in damage to an element.

With conventional ESD protection circuits in which gate voltage is raised by connecting a large capacitance element (having a capacitance of, for example, about several picofarads) between a gate and drain of an NMOS, the entire area increases due to the capacitance element. Furthermore, in many cases, an ESD protection circuit is formed in an I/O area in an LSI where a plurality of transistors are arranged like an array. Accordingly, a process for forming the capacitance element must be added. In addition, to obtain a capacitance of about several picofarads, a plurality of NMOSes each having a parasitic capacitance smaller than or equal to 1 femtofarad can be connected in parallel. In this case, however, many NMOSes must be used, so the entire area increases.

The present invention was made to solve the above problems. An object of the present invention is to provide a space-saving ESD protection circuit capable of effectively protecting an internal circuit against an ESD.

Embodiments of the present invention will now be described in detail with reference to the drawings.

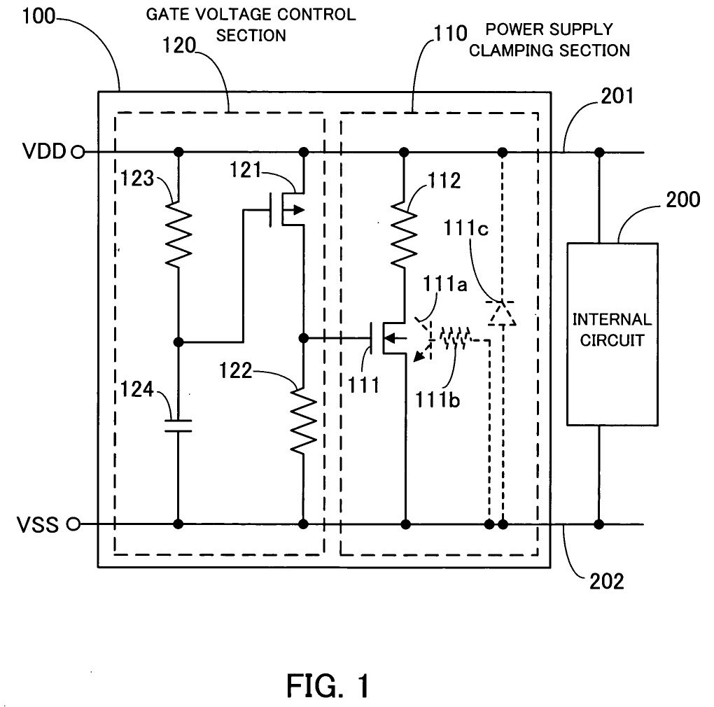

FIG. 1 is a circuit diagram showing the principles underlying an ESD protection circuit according to an embodiment of the present invention.

An ESD protection circuit 100 protects an internal circuit 200 against an ESD and comprises a power supply clamping section 110 including an NMOS 111 which is electrically connected between a power supply line 201 connected to a power supply terminal VDD and a power supply line 202 connected to a power supply terminal VSS and a gate voltage control section 120 for controlling the voltage of a gate of the NMOS 111.

In the power supply clamping section 110, one input-output terminal (drain or source) of the NMOS 111 is connected to the power supply line 201 via a resistor 112 and the other input-output terminal of the NMOS 111 is connected to the power supply line 202. In FIG. 1, a parasitic bipolar transistor 111a, a parasitic resistor 111b, and a parasitic diode 111c on the NMOS 111 are notionally shown by dotted lines. A collector and emitter of the parasitic bipolar transistor 111a correspond to the drain and source, respectively, of the NMOS 111. In this example, the drain of the NMOS 11 is connected to the power supply line 201.

If a plurality of NMOSes 111 are located to pass a powerful electric current generated by an ESD, there will be variation in the characteristics of these NMOSes 111. In that case, only one parasitic bipolar transistor 111a turns on and the electric current generated by the ESD flows to it. To avoid this, the resistor 112 is located (the details will be described later).

The gate voltage control section 120 includes a PMOS 121, resistors 122 and 123, and a capacitor 124. One input-output terminal of the PMOS 121 is connected to the power supply line 201 and the other input-output terminal of the PMOS 121 is connected to a gate terminal of the NMOS 111. One terminal of the resistor 122 is connected to the other input-output terminal of the PMOS 121 and the gate terminal of the NMOS 111 and the other terminal of the resistor 122 is connected to the power supply line 202. One terminal of the resistor 123 is connected to the power supply line 201 and the other terminal of the resistor 123 is connected to a gate terminal of the PMOS 121. One terminal of the capacitor 124 is connected to the other terminal of the resistor 123 and the gate terminal of the PMOS 121 and other terminal of the capacitor 124 is connected to the power supply line 202.

The PMOS 121 is in the on state for time determined by a time constant given by the resistor 123 and the capacitor 124. The voltage of the gate of the NMOS 111 in the power supply clamping section 110 rises due to voltage generated across the resistor 122.

The operation of the ESD protection circuit 100 will now be described.

It is assumed that a positive DC voltage is applied to the power supply terminal VDD and that the power supply terminal VSS is reference (GND). Then the PMOS 121 in the gate voltage control section 120 turns off. In this case, the gate terminal of the NMOS 111 in the power supply clamping section 110 is electrically connected to the power supply line 202 and the NMOS 111 turns off. Accordingly, the positive DC voltage applied to the power supply terminal VDD will be supplied to the internal circuit 200 and the internal circuit 200 performs predetermined operation.

When a positive ESD voltage is applied to the power supply terminal VDD with the power supply terminal VSS as reference (GND), an avalanche breakdown will occur in a depletion layer in an n-type drain junction area in the NMOS 111 when drain voltage rises to a certain value (Va). As a result, an electric current flows through a substrate and the potential of the substrate rises. When the difference between the potential of a base and emitter of the parasitic bipolar transistor 111a reaches about 0.7V, the parasitic bipolar transistor 111a turns on. Accordingly, an electric current generated by an ESD flows to the power supply terminal VSS via the power supply line 202 and the internal circuit 200 is protected.

In the gate voltage control section 120, the PMOS 121 is in the on state for time determined by a time constant given by the resistor 123 and the capacitor 124. The voltage of the gate of the NMOS 111 rises due to voltage generated across the resistor 122. As a result, a channel is formed on the surface of the silicon substrate below the gate. Electrons in the channel enter the depletion layer in the drain junction area and generate electron-hole pairs. The generated electrons flow to the drain and the generated holes flow through the substrate. This will induce an avalanche breakdown. Therefore, the parasitic bipolar transistor 111a turns on easily. That is to say, the parasitic bipolar transistor 111a on the NMOS 111 will turn on at a low drain voltage.

When a negative ESD voltage is applied to the power supply terminal VSS with the power supply terminal VDD as reference (GND), the internal circuit 200 will be protected in the same way.

On the other hand, when a positive ESD voltage is applied to the power supply terminal VSS with the power supply terminal VDD as reference (GND), the parasitic diode 111c which will turn on at about 0.7V is forward-biased. When the parasitic diode 111c turns on, an electric current generated by an ESD flows to the power supply terminal VDD and the internal circuit 200 is protected. When a negative ESD voltage is applied to the power supply terminal VDD with the power supply terminal VSS as reference (GND), the internal circuit 200 will be protected in the same way.

As described above, with the ESD protection circuit 100 according to the embodiment of the present invention, the parasitic bipolar transistor 111a on the NMOS 111 in the power supply clamping section 110 turns on at a low drain voltage, so an electric current generated by an ESD flows not through the internal circuit 200 but through the power supply clamping section 110. Therefore, the internal circuit 200 can be protected.

Furthermore, with the ESD protection circuit 100 according to the embodiment of the present invention, the capacitor 124 is used for controlling time for which the PMOS 121 is in the on state (time for which the voltage of the gate of the NMOS 111 is kept high), so a great capacitance value is not needed. About several femtofarads will be sufficient. Therefore, the area of the ESD protection circuit 100 does not increase.

An ESD protection circuit according to an embodiment of the present invention will now be described in detail.

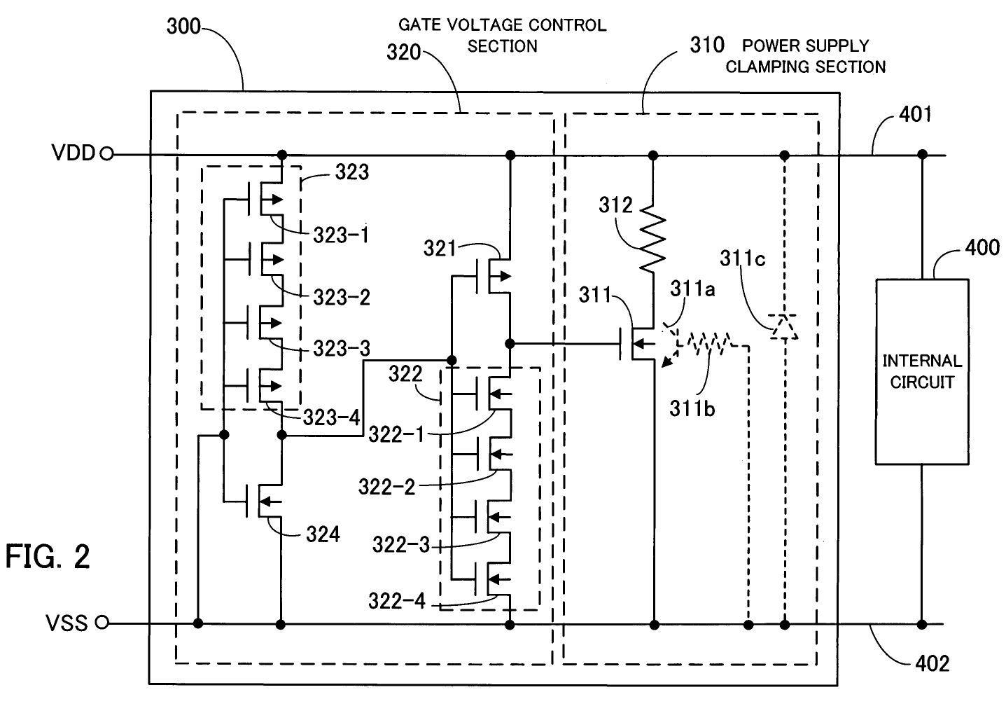

FIG. 2 is a detailed circuit diagram of an ESD protection circuit according to an embodiment of the present invention.

An ESD protection circuit 300 comprises a power supply clamping section 310 including an NMOS 311 which is electrically connected between a power supply line 401 connected to a power supply terminal VDD and a power supply line 402 connected to a power supply terminal VSS and a gate voltage control section 320 for controlling the voltage of a gate of the NMOS 311 in the power supply clamping section 310.

In the power supply clamping section 310, one input-output terminal (drain or source) of the NMOS 311 is connected to the power supply line 401 via a resistor 312 and the other input-output terminal of the NMOS 311 is connected to the power supply line 402. In FIG. 2, a parasitic bipolar transistor 311a, a parasitic resistor 311b, and a parasitic diode 311c on the NMOS 311 are notionally shown by dotted lines. A collector and emitter of the parasitic bipolar transistor 311a correspond to the drain and source, respectively, of the NMOS 311.

To pass a powerful electric current generated by an ESD, a plurality of NMOSes 311 are connected in parallel. Even if there is variation in the characteristics of the plurality of NMOSes 311 (variation in voltage at which an avalanche breakdown occurs), parasitic bipolar transistors 311a on the plurality of NMOSes 311 will turn on at the same time by the resistor 312.

The function of the resistor 312 will now be described concretely. If the plurality of NMOSes 311 are connected in parallel, voltages at which the parasitic bipolar transistors 311a turn on as a result of avalanche breakdowns at the time of a positive ESD voltage being applied to the power supply terminal VDD differ from one another. Moreover, due to a voltage drop by wiring resistance, there is a difference between voltages applied to a parasitic bipolar transistor 311a near to the power supply terminal VDD and a parasitic bipolar transistor 311a far from the power supply terminal VDD. Accordingly, it is uncertain which parasitic bipolar transistor 311a turns on. (However, a parasitic bipolar transistor 311a on an NMOS 311 in which avalanche breakdown voltage is low and which is near to the power supply terminal VDD will turn on easily.) When one parasitic bipolar transistor 311a turns on, an electric current generated by an ESD flows to the power supply terminal VSS and the potential of the power supply line 401 does not rise. Therefore, the other parasitic bipolar transistors 311a do not turn on and the electric current flows through the parasitic bipolar transistor 311a which turns on. As a result, the NMOS 311 which turns on will be damaged. The function of the resistor 312 is as follows. When one parasitic bipolar transistor 311a turns on and an electric current generated by an ESD flows to the power supply terminal VSS, the potential of the power supply line 401 is kept at a value greater than or equal to a certain value by the resistor 312. Accordingly, the other parasitic bipolar transistors 311a turn on easily. As a result, all of the parasitic bipolar transistors 311a turn on and an electric current generated by an ESD flows not through one NMOS 311 but through all of the NMOSes 311.

The gate voltage control section 320 includes a PMOS 321, resistor sections 322 and 323, and an NMOS 324. One input-output terminal of the PMOS 321 is connected to the power supply line 401 and the other input-output terminal of the PMOS 321 is connected to agate terminal of the NMOS 311. The resistor section 322 is located between the other input-output terminal of the PMOS 321 and the power supply line 402 and includes NMOSes 322-1, 322-2, 322-3, and 322-4 connected in series. The resistor section 323 is located among the power supply line 401 and gate terminals of the PMOS 321 and the resistor section 322 and includes PMOSes 323-1, 323-2, 323-3, and 323-4 connected in series. The NMOS 324 is connected between the resistor section 323 and the power supply line 402. Gate terminals of the PMOSes 323-1, 323-2, 323-3, and 323-4 and the NMOS 324 are connected to the power supply line 402.

The ON-state resistance of the NMOSes 322-1, 322-2, 322-3, and 322-4 connected in series in the resistor section 322 in the gate voltage control section 320 corresponds in terms of a function to the resistor 122 shown in FIG. 1. Similarly, the ON-state resistance of the PMOSes 323-1, 323-2, 323-3, and 323-4 connected in series in the resistor section 323 corresponds in terms of a function to the resistor 123 shown in FIG. 1. Parasitic capacitance in the NMOS 324 corresponds in terms of a function to the capacitor 124 shown in FIG. 1.

A plurality of, PMOSes 321 (not shown) are connected in parallel to control the voltage of the gate of the NMOS 311. In addition, a plurality of (ten, for example) NMOSes 324 are connected in parallel to control time for which the PMOS 321 is in the on state by parasitic capacitance in them. In FIG. 2, the four NMOSes 322-1, 322-2, 322-3, and 322-4 are connected in series in the resistor section 322. However, the number of NMOSes in the resistor section 322 is increased or decreased so that the voltage of the gate of the NMOS 311 in the power supply clamping section 310 will be a proper value (2.5V, for example) by the sum of their ON-state resistance values. Similarly, the number of PMOSes in the resistor section 323 may be changed properly to control a time constant.

The operation of the ESD protection circuit 300 will now be described.

It is assumed that a positive DC voltage is applied to the power supply terminal VDD and that the power supply terminal VSS is reference (GND). Then the PMOSes 323-1 through 323-4 in the resistor section 323 turn on and the PMOS 321 in the gate voltage control section 320 turns off. In this case, the NMOSes 322-1 through 322-4 turn on. Accordingly, the gate terminal of the NMOS 311 in the power supply clamping section 310 is electrically connected to the power supply line 402 via the resistor section 322 and the NMOS 311 turns off. As a result, the positive DC voltage applied to the power supply terminal VDD will be supplied to the internal circuit 400 and the internal circuit 400 performs predetermined operation.

When a positive ESD voltage is applied to the power supply terminal VDD with the power supply terminal VSS as reference (GND), an avalanche breakdown will occur in a depletion layer in an n-type drain junction area in the NMOS 311 when drain voltage rises to a certain value (Va). As a result, an electric current flows through a substrate and the potential of the substrate rises. When the difference between the potential of a base and emitter of the parasitic bipolar transistor 311a reaches about 0.7V, the parasitic bipolar transistor 311a turns on. Accordingly, an electric current generated by an ESD flows to the power supply terminal VSS via the power supply line 402 and the internal circuit 400 is protected.

In the gate voltage control section 320, the PMOS 321 is in the on state for time determined by a time constant given by the resistor section 323 and the parasitic capacitance in the NMOS 324. The voltage of the gate of the NMOS 311 rises due to voltage generated across the resistor section 322. As a result, a channel is formed on the surface of the silicon substrate below the gate. Electrons in the channel enter the depletion layer in the drain junction area and generate electron-hole pairs. The generated electrons flow to the drain and the generated holes flow through the substrate. This will induce an avalanche breakdown. Therefore, the parasitic bipolar transistor 311a turns on easily. That is to say, the parasitic bipolar transistor 311a on the NMOS 311 will turn on at a low drain voltage.

When a negative ESD voltage is applied to the power supply terminal VSS with the power supply terminal VDD as reference (GND), the internal circuit 400 will be protected in the same way.

On the other hand, when a positive ESD voltage is applied to the power supply terminal VSS with the power supply terminal VDD as reference (GND), the parasitic diode 311c which will turn on at about 0.7V is forward-biased. When the parasitic diode 311c turns on, an electric current generated by an ESD flows to the power supply terminal VDD and the internal circuit 400 is protected. When a negative ESD voltage is applied to the power supply terminal VDD with the power supply terminal VSS as reference (GND), the internal circuit 400 will be protected in the same way.

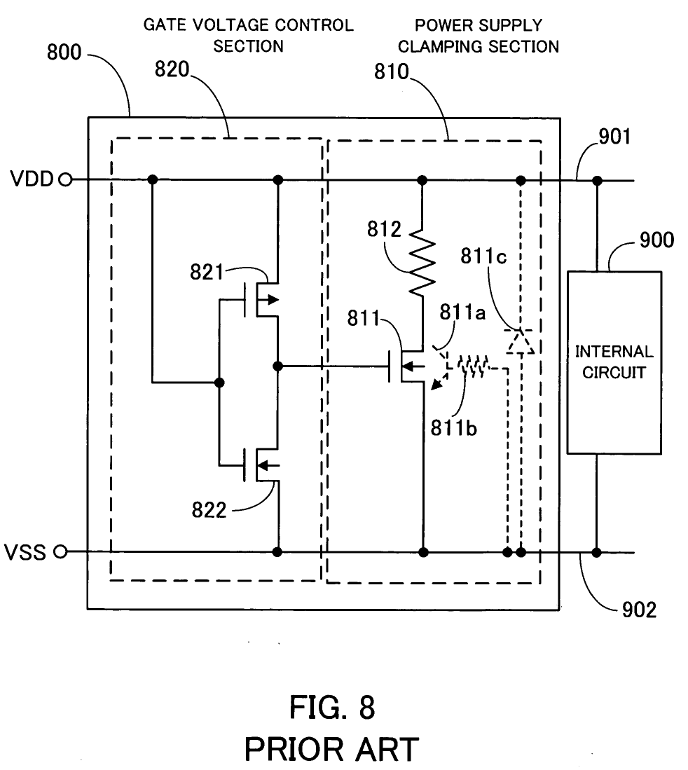

The simulation results of transient characteristics obtained when an ESD voltage of 3,000 volts is applied to the power supply terminal VDD of the ESD protection circuit 300 shown in FIG. 2 will now be illustrated. The simulation results of the transient characteristics of the conventional ESD protection circuit 800 shown in FIG. 8 will also be illustrated. These simulations were performed with a commercially available circuit simulator (HSPICE).

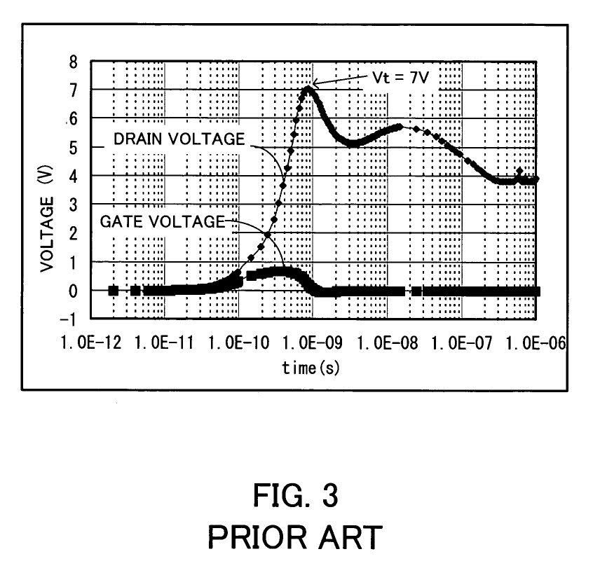

FIG. 3 shows the transient characteristics of the conventional ESD protection circuit at the time of an ESD voltage being applied.

In FIG. 3, a horizontal axis indicates time (s) and a vertical axis indicates voltage (V). The voltages of the drain and gate of the NMOS 811 in the power supply clamping section 810 are shown.

The parasitic bipolar transistor 811a on the NMOS 811 turns on at voltage Vt. As shown in FIG. 3, an increase in the voltage of the gate of the NMOS 811 in the conventional ESD protection circuit 800 by parasitic capacitance (not shown) is about 0.68V at the most. Accordingly, the voltage Vt is 7V and is high.

The voltage Vt must be lower than a voltage at which the internal circuit 400 is damaged, that is to say, than the voltage of a transistor (not shown) in the internal circuit 400 (through which an electric current generated by an ESD must not be passed). Furthermore, to prevent the parasitic bipolar transistor 311a from turning on at the time of the normal operation of the NMOS 311, the voltage Vt must be higher than the normal power supply voltage (rated power supply voltage). With the ESD protection circuit 300 according to the embodiment of the present invention, the voltage Vt is set by controlling the voltage of the gate of the NMOS 311.

The voltage of the gate of the NMOS 311 is controlled so that the number of the electron-hole pairs generated at the time of the electrons in the channel entering the depletion layer in the drain junction area will increase. The generated holes are detected as an electric current which flows through the substrate. Therefore, when the electric current which flows through the substrate is most powerful, a maximum number of electron-hole pairs are generated. If the voltage of the gate of the NMOS 311 meets this condition, proper voltage Vt will be obtained.

If the voltage of the gate of the NMOS 311 is too low, then the number of the electron-hole pairs generated is small and the electric current which flows through the substrate is weak. As a result, the potential of the substrate does not rise and the parasitic bipolar transistor 311a cannot turn on easily.

If the voltage of the gate of the NMOS 311 is too high, then a voltage drop occurs because of resistance in the channel and the number of the electron-hole pairs generated is small. As a result, the electric current which flows through the substrate is weak and the parasitic bipolar transistor 311a does not turn on.

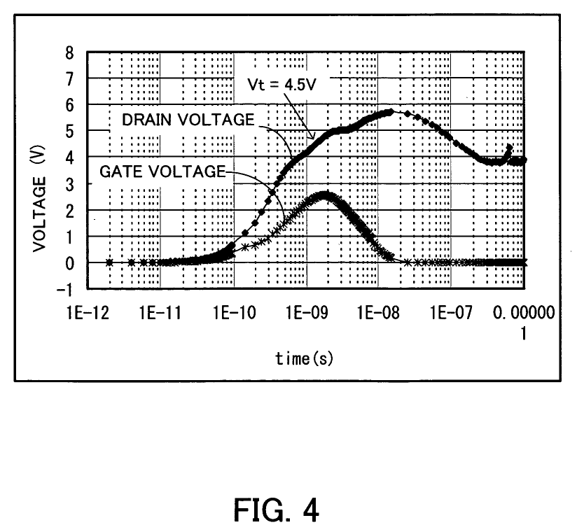

FIG. 4 shows the transient characteristics of the ESD protection circuit according to the embodiment of the present invention at the time of an ESD voltage being applied.

In FIG. 4, a horizontal axis indicates time (s) and a vertical axis indicates voltage (V). The voltages of the drain and gate of the NMOS 311 in the power supply clamping section 310 are shown.

The transient characteristics shown in FIG. 4 were obtained by performing a simulation on the ESD protection circuit 300 in which thirty-six NMOSes 311 are connected in parallel in the power supply clamping section 310, in which thirty-four PMOSes 321 are connected in parallel in the gate voltage control section 320, and in which ten NMOSes 324 are connected in parallel in the gate voltage control section 320. Each of the MOS field effect transistors included in the ESD protection circuit 300 has a gate length (L) of 0.34 μm and a gate width (W) of 1.56 μm.

As shown in FIG. 4, the voltage of the gate of the NMOS 311 in the ESD protection circuit 300 according to the embodiment of the present invention is raised to 2.5V. As a result, the voltage Vt can be decreased to 4.5V.

As described above, with the ESD protection circuit 300 according to the embodiment of the present invention, the parasitic bipolar transistor 311a on the NMOS 311 in the power supply clamping section 310 turns on at a low drain voltage, so an electric current generated by an ESD flows not through the internal circuit 400 but through the power supply clamping section 310. Therefore, the internal circuit 400 can be protected.

Furthermore, with the ESD protection circuit 300 according to the embodiment of the present invention, a great capacitance value is not necessary to a capacitor for controlling time for which the PMOS 321 is in the on state (time for which the potential of the gate of the NMOS 311 is kept high). About several femtofarads will be sufficient. Therefore, the parasitic capacitance in the NMOS 324 can be used and the area of the ESD protection circuit 300 does not increase.

In addition, with the ESD protection circuit 300 according to the embodiment of the present invention, resistors and capacitors can be formed by the use of the NMOSes 322-1, 322-2, 322-3, and 322-4, the PMOSes 323-1, 323-2, 323-3, and 323-4, and the NMOS 324. This saves processes for forming unnecessary elements. For example, IO macro cells in which transistors are arranged like an array can be fabricated efficiently.

An ESD protection circuit for protecting an internal circuit at the time of an ESD voltage being applied not to a power supply terminal VDD or VSS but to an input signal terminal of the internal circuit will now be described.

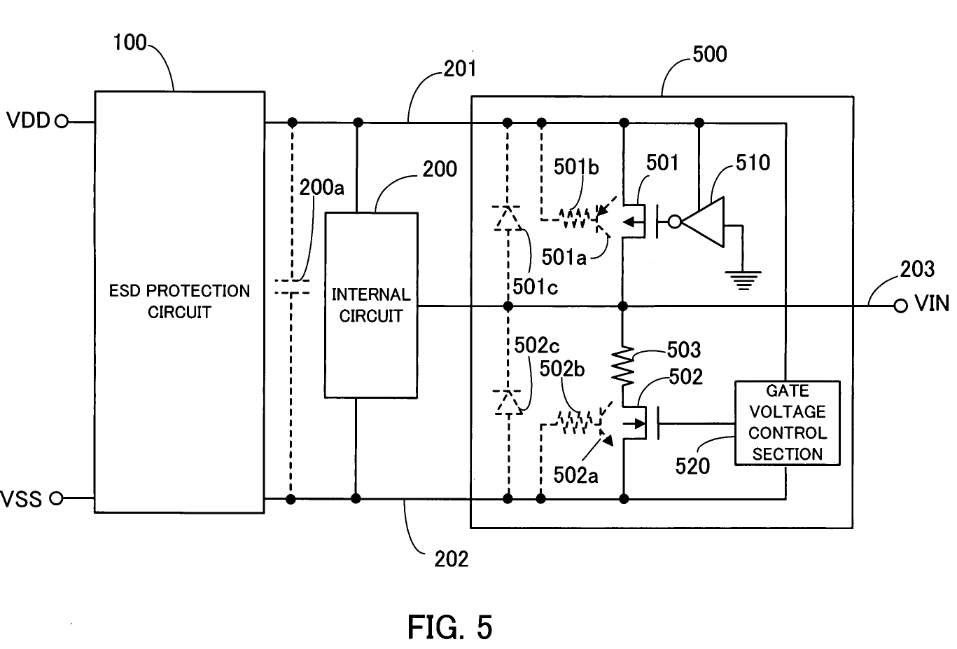

FIG. 5 is a circuit diagram of an ESD protection circuit for protecting an internal circuit at the time of an ESD voltage being applied to an input signal terminal of the internal circuit.

Components that are the same as those shown in FIG. 1 are marked with the same reference numerals and descriptions of them will be omitted.

An ESD protection circuit 500 for protecting an internal circuit 200 at the time of an ESD voltage being applied to an input signal terminal VIN of the internal circuit 200 comprises a PMOS 501 electrically connected between a power supply line 201 connected to a power supply terminal VDD and a signal line 203 connected to the input signal terminal VIN, an NMOS 502 electrically connected between the signal line 203 and a power supply line 202 connected to a power supply terminal VSS, a gate voltage control section 510 for controlling the voltage of a gate of the PMOS 501, and a gate voltage control section 520 for controlling the voltage of a gate of the NMOS 502.

The NMOS 502 is connected to the signal line 203 via a resistor 503. To pass a powerful electric current generated by an ESD, a plurality of NMOSes 502 are connected in parallel. As described above, even if there is variation in the characteristics of the plurality of NMOSes 502 (variation in voltage at which an avalanche breakdown occurs), a plurality of parasitic bipolar transistors 502a will turn on at the same time by the resistor 503.

In FIG. 5, a capacitor 200a having a capacitance value corresponding to the power-supply-to-power-supply capacitance of the internal circuit 200, a parasitic bipolar transistor 501a, a parasitic resistor 501b, and a parasitic diode 501c on the PMOS 501, and the parasitic bipolar transistor 502a, a parasitic resistor 502b, and a parasitic diode 502c on the NMOS 502 are notionally shown as parasitic elements by dotted lines. In this example, a drain of the NMOS 501 is connected to the power supply line 201.

The gate voltage control section 510 for controlling the voltage of the gate of the PMOS 501 has a CMOS inverter structure. For example, by connecting the gate terminals of the PMOS 821 and the NMOS 822 to GND in the gate voltage control section 820 in the conventional ESD protection circuit 800 shown in FIG. 8, the gate voltage control section 820 can be used as the gate voltage control section 510.

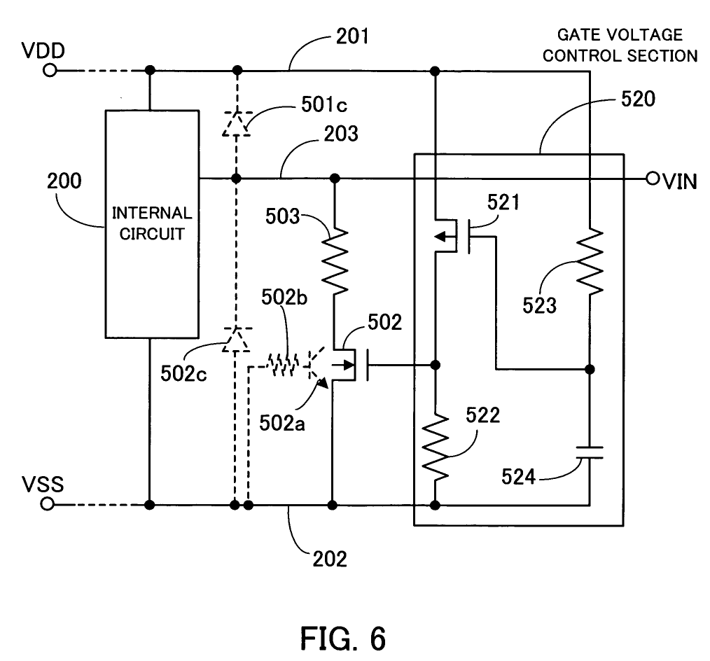

FIG. 6 shows the structure of the gate voltage control section included in the ESD protection circuit shown in FIG. 5 for controlling the voltage of the gate of the NMOS.

In FIG. 6, the PMOS 501, the gate voltage control section 510, etc. included in the ESD protection circuit 500 shown in FIG. 5 are not shown.

The circuit structure of the gate voltage control section 120 shown in FIG. 1 can be used for the gate voltage control section 520 for controlling the voltage of the gate of the NMOS 502. That is to say, the gate voltage control section 520 includes a PMOS 521, resistors 522 and 523, and a capacitor 524. One input-output terminal of the PMOS 521 is connected to the power supply line 201 and the other input-output terminal of the PMOS 521 is connected to a gate terminal of the NMOS 502. One terminal of the resistor 522 is connected to the other input-output terminal of the PMOS 521 and the gate terminal of the NMOS 502 and the other terminal of the resistor 522 is connected to the power supply line 202. One terminal of the resistor 523 is connected to the power supply line 201 and the other terminal of the resistor 523 is connected to a gate terminal of the PMOS 521. One terminal of the capacitor 524 is connected to the other terminal of the resistor 523 and the gate terminal of the PMOS 521 and other terminal of the capacitor 524 is connected to the power supply line 202.

Operation performed by the ESD protection circuit 500 at the time of an ESD voltage being applied to the input signal terminal VIN will now be described.

When a positive ESD voltage is applied to the input signal terminal VIN with the power supply terminal VDD as reference (GND), the PMOS 501 shown in FIG. 5 is forward-biased. Accordingly, the parasitic diode 501c turns on, an electric current flows to the power supply terminal VDD, and the internal circuit 200 is protected.

When a negative ESD voltage is applied to the input signal terminal VIN with the power supply terminal VDD as reference (GND), (1) the parasitic bipolar transistor 501a on the PMOS 501 turns on and an electric current generated by an ESD flows to the input signal terminal VIN, (2) the parasitic bipolar transistor 111a on the NMOS 111 in the ESD protection circuit 100 shown in FIG. 1 and located on the power supply side and the parasitic diode 502c on the NMOS 502 turn on and the electric current generated by the ESD flows to the input signal terminal VIN, and (3) the ESD occurs through the capacitor 200a having a capacitance value corresponding to the power-supply-to-power-supply capacitance of the internal circuit 200 and the parasitic diode 502c on the NMOS 502 and the electric current generated by the ESD flows to the input signal terminal VIN. As a result, the internal circuit 200 is protected.

Compared with the NMOS 111, the parasitic bipolar transistor 501a on the PMOS 501 carries a weak electric current. Therefore, if the parasitic bipolar transistor 501a on the PMOS 501, the parasitic diode 502c on the NMOS 502, and the parasitic bipolar transistor 111a in the ESD protection circuit 100 on the power supply side turn on at voltages Vt1p, Vfn, and Vt1n, respectively, then design should be made so that the following relation will hold:
Vt1n+Vfn<Vt1p

That is to say, the path described in the above (2) should be used as a main current path.

On the other hand, when a positive ESD voltage is applied to the input signal terminal VIN with the power supply terminal VSS as reference (GND), (1) the parasitic bipolar transistor 502a on the NMOS 502 turns on and an electric current generated by an ESD flows to the power supply terminal VSS, (2) the parasitic diode 501c on the PMOS 501 and the parasitic bipolar transistor 111a on the NMOS 111 in the ESD protection circuit 100 shown in FIG. 1 and located on the power supply side turn on and the electric current generated by the ESD flows to the power supply terminal VSS, and (3) the ESD occurs through the parasitic diode 501c on the PMOS 501 and the capacitor 200a having a capacitance value corresponding to the power-supply-to-power-supply capacitance of the internal circuit 200 and the electric current generated by the ESD flows to the power supply terminal VSS.

When a negative ESD voltage is applied to the input signal terminal VIN with the power supply terminal VSS as reference (GND), the parasitic diode 502 con the NMOS 502 is forward-biased. As a result, the parasitic diode 502c turns on and an electric current generated by an ESD flows to the input signal terminal VIN.

The operation of the ESD protection circuit 500 performed in the case of (1) at the time of a positive ESD voltage being applied to the input signal terminal VIN with the power supply terminal VSS as reference (GND) will now be described in detail with reference to FIGS. 5 and 6.

When a positive ESD voltage is applied to the input signal terminal VIN with the power supply terminal VSS as reference (GND), an avalanche breakdown will occur in a depletion layer in an n-type drain junction area in the NMOS 502. As a result, an electric current flows through a substrate and the potential of the substrate rises. When the difference between the potential of a base and emitter of the parasitic bipolar transistor 502a reaches about 0.7V, the parasitic bipolar transistor 502a turns on. Accordingly, an electric current generated by an ESD flows to the power supply terminal VSS via the power supply line 202 and the internal circuit 200 is protected.

At this time the parasitic diode 501c on the PMOS 501 shown in FIG. 5 is in the on state. Accordingly, the electric current generated by the ESD flows along the power supply line 201 connected to the power supply terminal VDD and the potential of the power supply line 201 is raised. As a result, in the gate voltage control section 520, the PMOS 521 is in the on state for time determined by a time constant given by the resistor 523 and the capacitor 524 connected to the power supply line 201. The potential of the gate of the NMOS 502 rises due to voltage generated across the resistor 522. Therefore, a channel is formed on the surface of the silicon substrate below the gate. Electrons in the channel enter the depletion layer in the drain junction area and generate electron-hole pairs. The generated electrons flow to the drain and the generated holes flow through the substrate. This will induce an avalanche breakdown. Accordingly, the parasitic bipolar transistor 502a turns on easily. That is to say, the parasitic bipolar transistor 502a on the NMOS 502 will turn on at a low drain voltage.

As a result, in addition to the path described in the above (2), the path described in (1) can be ensured quickly. This will decrease the load on the NMOS 111 in the ESD protection circuit 100 located on the power supply side.

As with the ESD protection circuit 300 shown in FIG. 2, a plurality of PMOSes 521 may be connected in parallel in order to control the voltage of the gate of the NMOS 502.

Furthermore, as with the ESD protection circuit 300, the resistor 522 can be formed by a plurality of NMOSes connected in series. Similarly, the resistor 523 can be formed by a plurality of PMOSes connected in series. The capacitor 524 can also be formed by a plurality of NMOSes connected in parallel. The number of these elements can be changed properly in order to set the voltage of the gate of the NMOS 502 to an appropriate value (2.5V, for example) at which a powerful electric current flows through the substrate or to control time for which the PMOS 521 is in the on state.

This saves processes for forming unnecessary elements. For example, IO macro cells in which transistors are arranged like an array can be fabricated efficiently.

In addition, the following circuit may be used as an ESD protection circuit for protecting an internal circuit at the time of an ESD voltage being applied to an input signal terminal of the internal circuit.

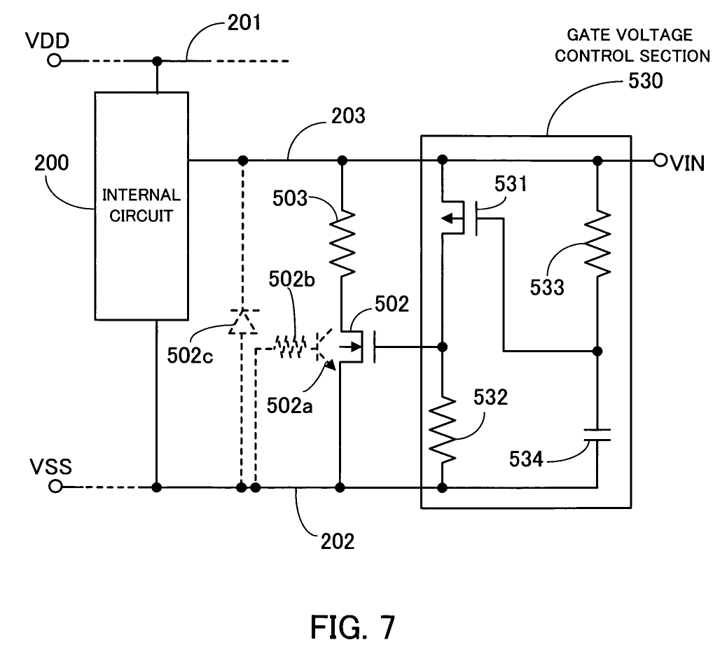

FIG. 7 is a circuit diagram of an ESD protection circuit for protecting an internal circuit at the time of an ESD voltage being applied to an input signal terminal of the internal circuit, according to another embodiment of the present invention.

An ESD protection circuit shown in FIG. 7 includes a gate voltage control section 530 for controlling the voltage of a gate of an NMOS 502. This gate voltage control section 530 differs from the gate voltage control section 520 shown in FIG. 5. The other components in the ESD protection circuit shown in FIG. 7 are the same as those shown in FIG. 5. In FIG. 7, they are marked with the same reference numerals or are not shown.

The gate voltage control section 530 for controlling the voltage of the gate of the NMOS 502 includes a PMOS 531, resistors 532 and 533, and a capacitor 534. One input-output terminal of the PMOS 531 is connected to a signal line 203 and the other input-output terminal of the PMOS 531 is connected to a gate terminal of the NMOS 502. One terminal of the resistor 532 is connected to the other input-output terminal of the PMOS 531 and the gate terminal of the NMOS 502 and the other terminal of the resistor 532 is connected to a power supply line 202. One terminal of the resistor 533 is connected to the signal line 203 and the other terminal of the resistor 533 is connected to a gate terminal of the PMOS 531. One terminal of the capacitor 534 is connected to the other terminal of the resistor 533 and the gate terminal of the PMOS 531 and other terminal of the capacitor 534 is connected to the power supply line 202.

The operation of the ESD protection circuit shown in FIG. 7 is the same as that of the ESD protection circuit 100 shown in FIG. 1. However, the power supply terminal VDD must be considered as an input signal terminal VIN. In this case, “H” (high level) or “L” (low level) is inputted to or outputted from the input signal terminal VIN at normal operation time. When input is at “H,” the gate terminal of the PMOS 531 is at “H” and the NMOS 502 does not operate. When input is at “L,” the PMOS 531 turns on. However, the gate terminal of the NMOS 502 is at “L” and the NMOS 502 does not operate. When a positive ESD voltage is applied to the input signal terminal VIN with a power supply terminal VSS as reference (GND), the voltage of the gate of the NMOS 502 is kept high by the resistor 533 and the capacitor 534 for a certain period of time. As a result, a parasitic bipolar transistor 502a turns on, an electric current generated by an ESD flows to the power supply terminal VSS, and an internal circuit 200 is protected.

As with the ESD protection circuit 300 shown in FIG. 2, a plurality of PMOSes 531 may be connected in parallel in order to control the voltage of the gate of the NMOS 502.

Furthermore, as with the ESD protection circuit 300, the resistor 532 can be formed by a plurality of NMOSes connected in series. Similarly, the resistor 533 can be formed by a plurality of PMOSes connected in series. The capacitor 534 can also be formed by a plurality of NMOSes connected in parallel. The number of these elements can be changed properly in order to set the voltage of the gate of the NMOS 502 to an appropriate value (2.5V, for example) at which a powerful electric current flows through the substrate or to control time for which the PMOS 531 is in the on state.

The present invention is applied to an ESD protection circuit for protecting an internal circuit in an LSI against an ESD.

According to the present invention, when a positive ESD voltage is applied to the first power supply terminal, the PMOS is in the on state for time determined by a time constant given by the resistor one terminal of which is connected to the first power supply line and the other terminal of which is connected to the gate terminal of the PMOS and the capacitor one terminal of which is connected to the other terminal of the resistor and the gate terminal of the PMOS and the other terminal of which is connected to the second power supply line and the voltage of the gate of the NMOS rises due to voltage generated across the resistor one terminal of which is connected to the other input-output terminal of the PMOS and the gate terminal of the NMOS and the other terminal of which is connected to the second power supply line. As a result, the potential of the substrate is raised, the parasitic bipolar transistor on the NMOS turns on at a low drain voltage, and the internal circuit is protected.

In addition, the capacitor is used for setting time for which the PMOS is in the on state, so small capacitance is sufficient. This enables space-saving.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. An electrostatic discharge protection circuit for protecting an internal circuit against an electrostatic discharge, the circuit comprising:
a power supply clamping section including an n-channel MOS field effect transistor electrically connected between a first power supply line connected to a first power supply terminal and a second power supply line connected to a second power supply terminal; and
a gate voltage control section for controlling the voltage of a gate of the n-channel MOS field effect transistor, wherein the gate voltage control section includes:
a p-channel MOS field effect transistor one input-output terminal of which is connected to the first power supply line and the other input-output terminal of which is connected to a gate terminal of the n-channel MOS field effect transistor;
a first resistor one terminal of which is connected to the other input-output terminal of the p-channel MOS field effect transistor and the gate terminal of the n-channel MOS field effect transistor and the other terminal of which is connected to the second power supply line;
a second resistor one terminal of which is connected to the first power supply line and the other terminal of which is connected to a gate terminal of the p-channel MOS field effect transistor; and
a capacitor one terminal of which is connected to the other terminal of the second resistor and the gate terminal of the p-channel MOS field effect transistor and the other terminal of which is connected to the second power supply line.

2. The electrostatic discharge protection circuit according to claim 1, wherein the gate voltage control section controls the voltage of the gate of the n-channel MOS field effect transistor so that a voltage at which a parasitic bipolar transistor on the n-channel MOS field effect transistor turns on will be lower than a voltage at which the internal circuit is damaged.

3. The electrostatic discharge protection circuit according to claim 1, wherein the first resistor is a plurality of n-channel MOS field effect transistors connected in series.

4. The electrostatic discharge protection circuit according to claim 1, wherein the second resistor is a plurality of p-channel MOS field effect transistors connected in series.

5. The electrostatic discharge protection circuit according to claim 1, wherein the capacitor is a plurality of n-channel MOS field effect transistors connected in parallel.

6. An electrostatic discharge protection circuit for protecting an internal circuit electrically connected between a first power supply line connected to a first power supply terminal and a second power supply line connected to a second power supply terminal from an electrostatic discharge voltage applied to an input signal terminal, the circuit comprising:
an n-channel MOS field effect transistor electrically connected between a signal line connected to the input signal terminal and the second power supply line; and
a gate voltage control section for controlling the voltage of a gate of the n-channel MOS field effect transistor, wherein the gate voltage control section includes:
a p-channel MOS field effect transistor one input-output terminal of which is connected to the first power supply line and the other input-output terminal of which is connected to a gate terminal of the n-channel MOS field effect transistor;
a first resistor one terminal of which is connected to the other input-output terminal of the p-channel MOS field effect transistor and the gate terminal of the n-channel MOS field effect transistor and the other terminal of which is connected to the second power supply line;
a second resistor one terminal of which is connected to the first power supply line and the other terminal of which is connected to a gate terminal of the p-channel MOS field effect transistor; and
a capacitor one terminal of which is connected to the other terminal of the second resistor and the gate terminal of the p-channel MOS field effect transistor and the other terminal of which is connected to the second power supply line.

7. The electrostatic discharge protection circuit according to claim 6, wherein the first resistor is a plurality of n-channel MOS field effect transistors connected in series.

8. The electrostatic discharge protection circuit according to claim 6, wherein the second resistor is a plurality of p-channel MOS field effect transistors connected in series.

9. The electrostatic discharge protection circuit according to claim 6, wherein the capacitor is a plurality of n-channel MOS field effect transistors connected in parallel.

10. The electrostatic discharge protection circuit according to claim 6, further comprising:
a second p-channel MOS field effect transistor electrically connected between the first power supply line and the signal line; and
a second gate voltage control section for controlling the voltage of a gate of the second p-channel MOS field effect transistor.

11. The electrostatic discharge protection circuit according to claim 10, wherein the second gate voltage control section is a CMOS inverter an input terminal of which is grounded.

12. An electrostatic discharge protection circuit for protecting an internal circuit electrically connected between a first power supply line connected to a first power supply terminal and a second power supply line connected to a second power supply terminal from an electrostatic discharge voltage applied to an input signal terminal, the circuit comprising:
an n-channel MOS field effect transistor electrically connected between a signal line connected to the input signal terminal and the second power supply line; and
a gate voltage control section for controlling the voltage of a gate of the n-channel MOS field effect transistor, wherein the gate voltage control section includes:
a p-channel MOS field effect transistor one input-output terminal of which is connected to the signal line and the other input-output terminal of which is connected to a gate terminal of the n-channel MOS field effect transistor;
a first resistor one terminal of which is connected to the other input-output terminal of the p-channel MOS field effect transistor and the gate terminal of the n-channel MOS field effect transistor and the other terminal of which is connected to the second power supply line;
a second resistor one terminal of which is connected to the signal line and the other terminal of which is connected to a gate terminal of the p-channel MOS field effect transistor; and
a capacitor one terminal of which is connected to the other terminal of the second resistor and the gate terminal of the p-channel MOS field effect transistor and the other terminal of which is connected to the second power supply line.

13. The electrostatic discharge protection circuit according to claim 12, wherein the first resistor is a plurality of n-channel MOS field effect transistors connected in series.

14. The electrostatic discharge protection circuit according to claim 12, wherein the second resistor is a plurality of p-channel MOS field effect transistors connected in series.

15. The electrostatic discharge protection circuit according to claim 12, wherein the capacitor is a plurality of n-channel MOS field effect transistors connected in parallel.

16. The electrostatic discharge protection circuit according to claim 12, further comprising:
a second p-channel MOS field effect transistor electrically connected between the first power supply line and the signal line; and
a second gate voltage control section for controlling the voltage of a gate of the second p-channel MOS field effect transistor.

17. The electrostatic discharge protection circuit according to claim 16, wherein the second gate voltage control section is a CMOS inverter an input terminal of which is grounded.
